(19) United States
(12) Patent Application Publication
(10) Pub. No.: US 2007/0070058 A1
(43) Pub. Date: Mar. 29, 2007

(54) PLASMA DISPLAY APPARATUS

(76) Inventors: Won Jae Kim, Masan-si (KR); Oh Hun Kwon, Busan-si (KR); Sung Im Lee, Gumi-si (KR)

Correspondence Address: FLESHNER & KIM, LLP, P.O. BOX 221200, CHANTILLY, VA, 20153, US

(21) Appl. No.: 11/426,987

(22) Filed: Jun. 28, 2006

(30) Foreign Application Priority Data
Aug. 8, 2005 (KR) 10-2005-0072250

(51) Int. Cl. G09G 5/00

(52) U.S. Cl. 345/214

(57) ABSTRACT

A plasma display apparatus is provided. The waveform of a set up signal applied in a reset period rises in at least two steps and first and second switches provided for applying the set up signal are simultaneously turned on. Therefore, it is possible to prevent strong discharge from being generated in the reset period and to thus improve picture quality

### BACKGROUND OF THE INVENTION

1. Field of the Invention

The present invention relates to a plasma display apparatus, and more particularly, to a plasma display apparatus that is capable of controlling a switching point of time at which at least one ramp switch for applying a ramp set up signal in a reset period is turned on to stably apply the set up signal.

2. Description of the Conventional Art

In a plasma display apparatus, discharge cells are formed between a lower substrate on which barrier ribs are formed and an upper substrate that faces the lower substrate and vacuum ultraviolet (VUV) generated when inert gases in the discharge cells are discharged by a high frequency voltage collides with phosphors to generate light so that an image is displayed.

A plurality of address electrodes X are formed on the lower substrate and a plurality of scan electrodes Y and sustain electrodes Z that intersect the address electrodes X are formed on the upper substrate.

The plasma display apparatus is time division driven such that one frame is divided into various sub fields having different numbers of time of light emission in order to implement gray levels of an image. Each sub field is composed of a reset period R for initializing wall charges in the discharge cells, an address period A for selecting a scan line to select a discharge cell from the selected scan line, and a sustain period S for implementing gray levels in accordance with the number of times at which sustain discharge is generated.

First, in the reset period R, a set up signal R_up and a set down signal R_dn are continuously supplied to the scan electrodes Y. When the set up signal is supplied, reset discharge is generated in the discharge cells and wall charges are accumulated on a dielectric layer. Then, when the set down signal is supplied, the wall charges in the discharge cells are erased to be initialized.

The set up signal R_up may have a waveform that continuously rises to a predetermined set up voltage or a waveform that sequentially rises to the predetermined set up voltage in two steps. In particular, in the present specification, the problems of the set up signal R_up having the waveform that sequentially rises in two steps will be described.

That is, the conventional set up signal R_up illustrated in FIG. 1 has the waveform that primarily rises to a first set up voltage Vsetup1 and that secondarily rises to a second set up voltage Vsetup2.

When the address period A starts, to the scan electrodes Y, a scan voltage Vsc is applied and a negative (−) scan pulse is sequentially applied and a positive (+) data pulse is applied to the address electrodes X in synchronization with the scan pulse so that address discharge is generated between the scan electrodes Y and the address electrodes X due to a voltage difference caused by the scan pulse and the data pulse.

The scan pulse has a waveform that falls to the lowermost scan voltage −Vy.

Finally, in the sustain period S, a sustain pulse is alternately supplied to the scan electrodes Y and the sustain electrodes Z so that sustain discharge is generated by a voltage difference Vs between the scan electrodes Y and the sustain electrodes Z to display an image on a screen.

Therefore, the plasma display apparatus has a circuit structure illustrated in FIG. 2, which includes a set up driver 2 for applying the set up signal R_up, a set down driver 3 for applying the set down signal R_dn, and a scan driver 4 for applying the scan voltage Vsc. The signals generated by the drivers 2, 3, and 4 are applied to the scan electrodes Y.

To be specific, the set up driver 2 includes a first driver a for having the voltage of the set up signal R_up increase to the first set up voltage Vsetup1 and a second driver b for having the voltage of the set up signal R_up further increase by the second set up voltage Vsetup2.

That is, according as the first switch SR1 included in the first driver a is turned on, the voltage of the scan electrodes Y increases to the first set up voltage Vsetup1. According as the second switch SR2 and the variable resistor R₁ included in the second driver b are driven, the voltage of the scan electrodes Y further increases by the second set up voltage Vsetup2.

The first set up voltage Vsetup1 uses a sustain voltage Vs source and the second set up voltage Vsetup2 uses an additional external power source. The variable resistor connected to the second switch SR2 is controlled so that the voltage of the scan electrodes Y gradually increases to the second set up voltage Vsetup2 with a predetermined slope.

The set up signal R_up supplied by the set up driver 2 is applied to the scan electrodes Y through a scan integrated circuit (IC) 4′ only when the voltage that passes through the scan IC 4′ is no less than the minimum operation voltage required for driving the scan IC.

In general, the minimum operation voltage of the scan IC 4′ is about several to several tens V. At the moment where the switch is turned on so that a predetermined signal is applied to the scan electrodes Y, the voltage of the scan electrodes Y rapidly increases by the minimum operation voltage of the scan IC.

That is, according as the first switch SR1 is turned on, the voltage of the scan electrodes Y rapidly increases at the point of time where the first set up voltage Vsetup1 is applied. According as the second switch SR2 is turned on, the voltage of the scan electrodes Y rapidly increases at the point of time where the second set up voltage Vsetup2 is applied. As described above, when the signal whose voltage rapidly increases is applied to the scan electrodes Y, the wall charges are rapidly accumulated so that undesired strong discharge is generated.

At the point of time where the voltage of the set up signal R_up primarily increases, although the voltage of the scan electrodes Y rapidly increases, since the voltage is less than a discharge start voltage, there is no chance of generating strong discharge, However, at the point where the voltage of the set up signal R_up secondarily increases, since the voltage no less than the minimum operation voltage of the scan IC is applied in the state where the scan electrodes sustain a predetermined voltage level, the voltage of the scan electrodes Y rapidly increases as illustrated in the bolded parts so that undesired strong discharge is generated in the reset period R and that a bright point is displayed.

### SUMMARY OF THE INVENTION

Accordingly, an object of the present invention is to solve at least the problems and disadvantages of the background art, A plasma display apparatus according to the present invention includes a set up driver including at least two switches in order to apply a set up signal whose waveform sequentially rises in at least two steps in a reset period of at least one sub field to scan electrodes and a set up controller for controlling switching timing so that the at least two switches are simultaneously turned on. Therefore, it is possible to prevent undesired strong discharge from being generated in the reset period.

The at least two switches include first and second switches for applying a waveform that gradually rises to a predetermined voltage level. Therefore, the first switch is connected to a positive sustain voltage source applied to the scan electrodes in a sustain period and the second switch is connected to a positive scan voltage source applied to the scan electrodes in an address period.

The scan voltage source is connected to a scan switch turned on in the address period to apply a bias voltage to the scan electrodes.

The set up controller simultaneously turns on the first and second switches only when the voltage of the scan electrode is less than the scan voltage level so that the voltage of the scan electrodes does not rapidly increases.

The first switch applies a waveform that gradually rises to a predetermined voltage level and the second switch applies a waveform that vertically rises to a predetermined voltage level.

The set up controller controls switching timing so that the first and second switches are sequentially turned on in the reset period so that a set up signal having a waveform that gradually rises to a first set up voltage and a waveform that gradually rises by a second set up voltage is supplied.

The set up controller primarily turns on the first switch and secondarily turns on the second switch when the voltage level of the scan electrodes that increases according as the first switch is turned on is less than a predetermined voltage level.

The predetermined voltage level is a positive scan voltage level, Although a voltage is secondarily applied after the voltage less than the predetermined voltage level is applied to the scan electrodes, strong discharge is not generated in the reset period.

That is, the set up signal applied to the scan electrodes in the reset period is composed of the first set up signal whose waveform rises with a first slope and the second set up signal whose waveform rises with a second slope to be continuous to the first set up signal. The first slope is larger than the second slope. The point of time at which the set up controller is turned on is controlled to form the waveform that gradually rises such that the second slope of the waveform is less than 90 degrees. Therefore, it is possible to prevent strong discharge from being generated in the reset period.

### BRIEF DESCRIPTION OF THE DRAWINGS

FIG. 1 illustrates driving waveforms applied to a conventional plasma display panel (PDP);

FIG. 2 illustrates a driving circuit of the conventional PDP;

FIG. 3 illustrates a first embodiment of a driving circuit of a PDP according to the present invention;

FIG. 4A illustrates a first embodiment of a set up signal applied to the PDP according to the present invention;

FIG. 4B illustrates a second embodiment of a set up signal applied to the PDP according to the present invention;

FIG. 5 illustrates a second embodiment of a driving circuit of the PDP according to the present invention; and

FIG. 6 illustrates a third embodiment of a set up signal applied to the PDP according to the second embodiment of the present invention.

### DETAILED DESCRIPTION OF THE PREFERRED EMBODIMENTS

Preferred embodiments of driving waveforms for driving plasma display apparatus and panel according to the present invention will be described in detailed with reference to the accompanying drawings.

A plasma display panel (PDP) is time division driven such that one frame is divided into a plurality of sub fields in order to display an image. Each sub field is composed of a reset period for initializing the charge states of discharge cells to be the same, an address period for addressing image data in a selected scan line, and a sustain period for generating sustain discharge in a cell (on cell) selected in accordance with the image data to implement gray levels.

The present invention relates to the waveform of a set up signal applied to scan electrodes in the reset period, the circuit structure of a set up driver for supplying the set up signal, and a set up controller for controlling the switching timing of the set up driver.

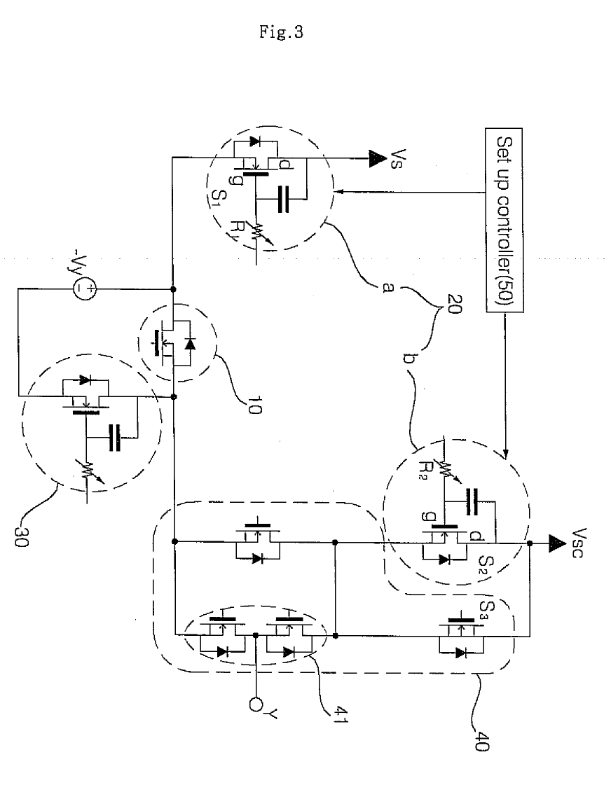

Hereinafter, the circuit structure of the plasma display apparatus including the set up driver and the set up controller according to the present invention will be described with reference to FIG. 3.

As illustrated in FIG. 3, the plasma display apparatus according to the present invention includes a set up driver 20 for applying a set up signal, a set down driver 30 for applying a set down signal, and a scan driver 40 for applying a scan voltage Vsc to the scan electrodes Y and further includes a pass switch 10 that is turned on and off on the path where a signal is applied from the set up driver 20 or the set down driver 30 to the scan electrodes to determine whether to apply the signal.

The set up driver 20 includes a first driver a for applying a first set up voltage to the scan electrodes and a second driver b for applying a second set up voltage to the scan electrodes having the first set up voltage level.

The set up driver 20 according to the present invention does not use an additional voltage source in order to apply the set up signal R_up but uses a positive sustain voltage Vs applied to the scan electrodes in the sustain period and the positive scan voltage Vsc applied to the scan electrodes in the address period to form a set up voltage.

That is, when the reset period R starts, the set up signal R_up whose waveform rises in at least two steps is applied to the scan electrodes Y so that wall charges are accumulated on discharge cells. The maximum voltage level of the set up signal is the sum of the scan voltage Vsc and the sustain voltage Vs.

According as the first switch S1 included in the first driver a is turned on, the waveform of the set up signal primarily gradually rises by the first set up voltage. According as the second switch S2 included in the second driver b is turned on, the waveform of the set up signal secondarily gradually rises by the second set up voltage.

The waveform that gradually rises to a predetermined voltage level is referred to as a ramp waveform. In order to supply the set up signal having the ramp waveform, variable resistors R1 and R2 and capacitors are connected to the first and second switches S1 and S2. That is, the drains d of the first and second switches S1 and S2 are connected to the direct current (DC) power sources Vs and Vsc and the variable resistors R1 and R2 and the capacitors are connected to the gates g of the first and second switches S1 and S2.

Therefore, the slope of the waveform of the set up signal R_up is determined by the time constant value of the RC connected to the gate terminal of the first switch S1 or the second switch S2.

Therefore, when the first switch S1 is turned on, the voltage of the scan electrodes Y gradually increases by the sustain voltage Vs and the slope of the rising waveform is controlled by the variable resistor R1 connected to the first switch.

When the second switch S2 is turned on, the voltage of the scan electordes Y gradually increases by the scan voltage Vsc and the slope of the rising waveform is controlled by the variable resistor R2 connected to the second switch.

As described above, since the set up driver 20 according to the present invention does not use an additional voltage source when the set up signal R_up is applied but uses the sustain voltage Vs source and the scan voltage Vsc source to supply the signal whose waveform rises in at least two steps, the structure of a power source terminal is simplified and the cost of forming a circuit is reduced.

The set down driver 30 includes a set down switch for applying the set down signal whose waveform falls to a negative voltage level −Vy to the scan electrodes Y in order to erase the wall charges in the discharge cells. When the set down signal is applied, the pass switch 10 is turned off to intercept the flow of current from another voltage source so that the voltage level of the scan electrodes Y falls to the set down lowermost voltage −Vy.

The scan driver 40 includes a scan switch S3 for applying the positive scan voltage Vsc to the scan electrodes Y with the start of the address period and a scan integrated circuit (IC) 41 that is turned on or off on the path where the scan voltage is applied to the scan electrodes Y to determine whether to apply the scan voltage.

The scan IC 41 is composed of two high and low switches that are serially connected to each other and applies a voltage to the scan electrodes Y according as the switches are supplementarily turned on. According as the high switch is turned on and the low switch is turned off in the address period, the scan voltage Vsc is applied to the scan electrodes Y through the scan switch S3.

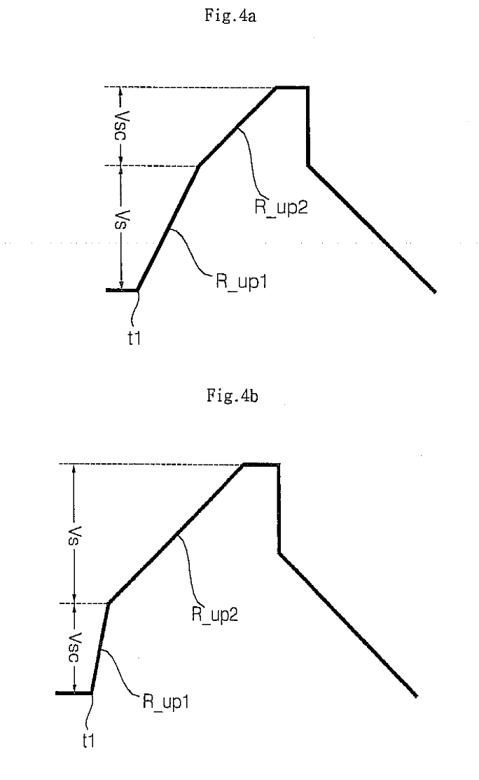

The point of time at which the first and second switches S1 and S2 included in the set up driver 20 are turned on is controlled by the set up controller 50. The waveforms of the set up signal that is supplied to the scan electrodes Y according as the first and second switches are simultaneously turned on are illustrated in FIGS. 4A and 4B.

The waveforms of the set up signal illustrated in FIGS. 4A and 4B rise in at least two steps and the slopes of the waveforms are different from each other.

As illustrated in FIG. 4A, the waveform of the first set up signal R_up1 gradually rises by the sustain voltage Vs and the waveform of the second set up signal R_up2 additionally rises by the scan voltage Vsc. As illustrated in FIG. 4B, the waveform of the first set up signal R_up1 gradually rises by the scan voltage Vsc and the waveform of the second set up signal R_up2 additionally gradually rises by the sustain voltage Vs.

It is noted that the waveforms of the first set up signal R_up1 and the second set up signal R_up2 are ramp waveforms that gradually rise with a predetermined slope.

As described above, the variable resistors R1 and R2 connected to the first and second switches S1 and S2 are controlled to form various waveforms of the set up signal R_up that rise in at least two steps according to the present invention.

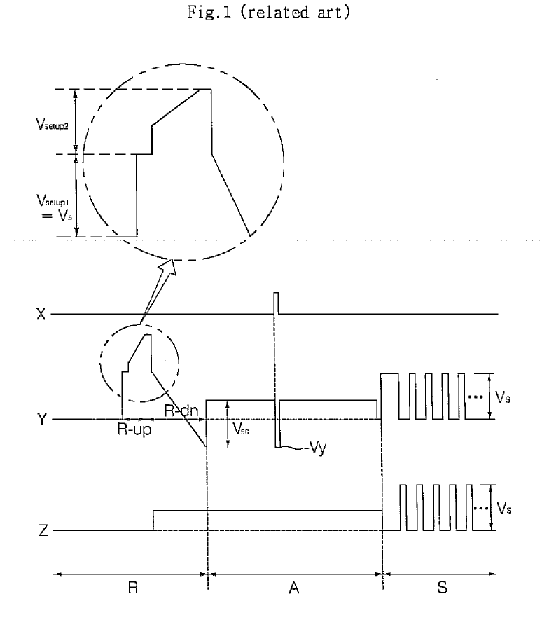

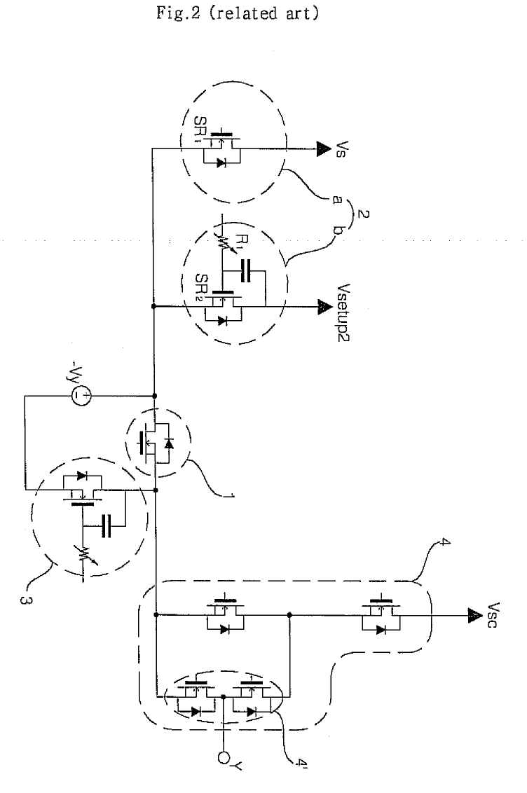

Since the first and second switches S1 and S2 are simultaneously turned on by the set up controller 50 according to the present invention, the voltage of the scan electrodes does not rapidly increases as illustrated in the bolded parts of FIG. 1.

To be specific, when the first switch S1 of FIG. 3 is turned on, the sustain voltage Vs is primarily supplied to the scan electrodes Y through the bodly diode of the low switch that constitutes the scan IC 41. When the second switch S2 is turned on at the same time, the scan voltage Vsc is applied to the scan electrodes Y through the high switch of the scan IC 41.

As a result, since the voltage is supplied to the scan IC 41 at once at the moment where the first and second switches S1 and S2 are simultaneously turned on and a voltage starts to be applied to the scan electrodes Y when the voltage applied to the scan IC is no less than the minimum operation voltage of the scan IC, the point of time at which the voltage of the scan electrodes Y is t1 of FIGS. 4A and 4B.

Therefore, although a low price scan IC whose minimum operation voltage is large is applied to the circuit, when the first and second switches S1 and S2 are simultaneously turned on, the set up signal R_up is not distorted by the operation voltage of the scan IC 41. There is no chance of generating strong discharge at the point of time t1 although the voltage of the scan electrodes Y rapidly increases since the voltage of the scan electrodes Y is less than a discharge start voltage.

Since an additional DC power source is not used for applying the set up signal R_up but the sustain voltage source Vs applied to the scan electrodes Y in the sustain period and the scan voltage source Vsc applied for forming the scan bias voltage are used, the structure of the power source terminal is simplified and the cost is reduced compared with a conventional circuit.

The set up controller 50 according to the present invention simultaneouslly turns on the first and second switches S1 and S2 only when the voltage of the scan electrodes Y is less than a predetermined voltage level (that is, only when strong discharge is not generated according as the set up signal is applied to the scan electrodes Y) so that it is possible to stably apply the set up signal R_up compared with the first embodiment, which is referred to as a second embodiment.

The set up controller 50 according to the present invention first turns on one of the first and second switches S1 and S2 and then, sequentially turns on the other switch only when the voltage level of the scan electrodes Y is less than a predetermined voltage level, which is referred to as a third embodiment.

As a result, the voltage of the scan electrodes Y primarily increases by the first turned on switch and the other switch is turned on only when the increased voltage level is less than the predetermined voltage level to secondarily apply the voltage so that strong discharge is not generated in the discharge cells although the voltage of the scan electrodes Y rapidly increases by the minimum operation voltage of the scan IC 41.

The predetermined voltage level is the scan voltage Vsc.

Since discharge is not generally affected when the scan IC 41 starts to operate in the state where a voltage no more than 100V is applied to the scan electrodes Y, the set up controller 50 secondarily turns on the switch only when the voltage applied to the scan electrodes Y is less than the scan voltage Vsc of about 70V to 100V.

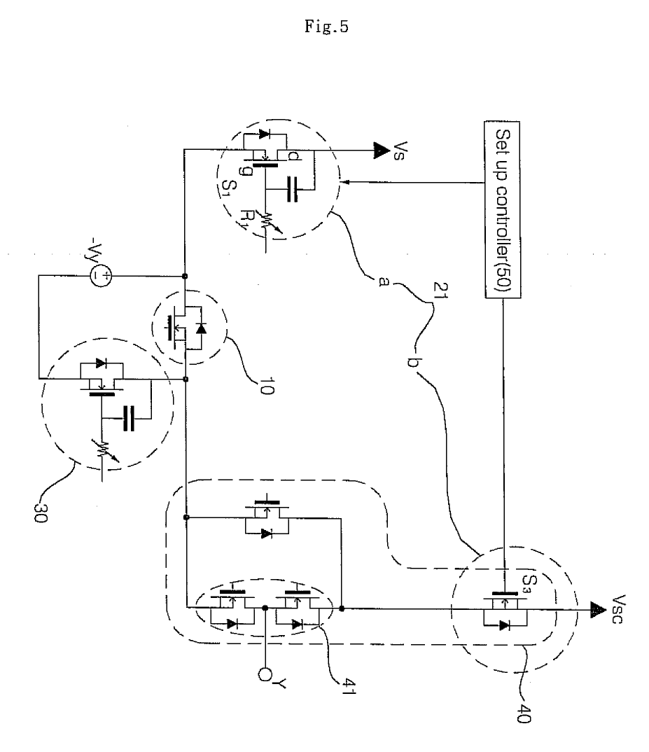

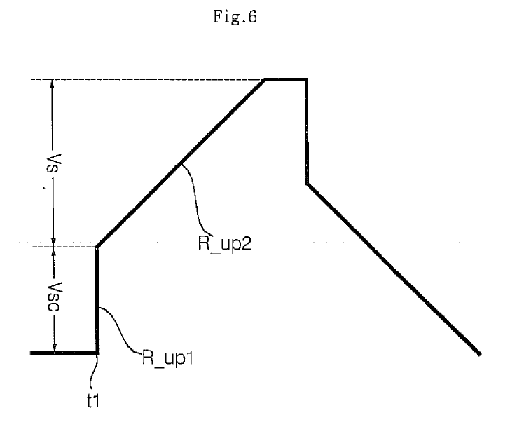

The circuit of the set up driver 21 according to the present invention may be constututed as illustrated in FIG. 5. In the circuit, the waveform of the set up signal supplied in the reset period R is as illustrated in FIG. 6, which is referred to as a fourth embodiment.

That is, the set up driver 21 includes a first driver a for applying a first set up voltage to the scan electrodes and a second driver b for applying a second set up voltage to the scan electrodes having the first set up voltage level. Forming the set up voltage using the positive sustain voltage Vs applied to the scan electrodes in the sustain period and the positive scan voltage Vsc applied in the address period in order to apply the set up signal R_up is the same as illustrated in FIG. 3 that describes the set up driver.

However, the first switch S1 included in the first driver a according to the present invention is connected to the sustain voltage source Vs and a variable resistor and a capacitor in order to form the waveform that gradually rises, the second switch S3 included in the second driver b is connected to the scan voltage source Vsc, and a scan switch S3 that is not connected to the variable resistor and the capacitor is commonly used.

That is, in the circuit illustrated in FIG. 3, the variable resistors and the capacitors are connected to the first and second switches S1 and S2 to supply the waveforms that gradually rise, respectively. However, in the circuit illustrated in FIG. 5, since the scan switch S3 for supplying the scan voltage Vsc in the address period is commonly used as the second switch, the waveform that gradually rises is supplied by the first switch and the waveform that vertically rises is supplied by the second switch.

The set up controller 50 primarily turns on the second switch S3 in the reset period so that the first set up signal R_up1 whose waveform vertically rises by the scan voltage Vsc is applied and secondarily turns on the first switch S1 when the voltage level of the scan electrodes Y that increases according as the second switch is turned on is less than a predetermined voltage level so that the second set up signal R_up2 whose waveform gradually rises by the sustain voltage Vs is applied to the scan electrodes Y.

Therefore, since the scan electrodes Y have the voltage of a ground level at the point of time t1 where the reset period starts as illustrated in FIG. 6, there is no chance of generating erroneous discharge although the scan voltage Vsc is primarily applied since the voltage level of the scan electrodes Y is less than the discharge start voltage.

Since the set up controller 50 secondarily gradually applies the sustain voltage Vs only when the voltage level of the scan electrodes Y is less than the predetermined voltage level, weak discharge is generated in the discharge cells.

According to the above-described first to fourth embodiments, since the set up controller 50 controls the switching timing of the set up drivers 20 and 21 by simultaneously turning on the first and second switches S1 and S2 for having the waveforms of the set up signal rise in at least two steps, by turning on the first and second switches S1 and S2 in the state where the voltage applied to the scan electrodes Y is no more than the scan voltage Vsc, or by first turning on one of the first and second switches S1 and S2 and then, sequentially turning on the other switch in the state where the voltage applied to the scan electrodes Y is no more than the scan voltage Vsc, strong discharge is not generated by starting the operation of the scan IC 41.

Also, in the fourth embodiment of the present invention, since the scan switch S3 is commonly used without additionally providing the second switch, it is possible to make the circuit structure simpler.

The waveforms of the set up signal R_up supplied according to the first to fourth embodiments will be described.

The set up signal R_up applied in the reset period R is composed of the first set up signal R_up1 having the waveform with a first slope and the second set up signal R_up2 having the waveform with a second slope. The second slope is smaller than the first slope and is less than 90 degrees.

That is, since there is no chance of generating strong discharge in the state where the scan electrodes Y have the ground level, the waveform of the first set up signal R_up1 vertically rises or gradually rises. Since there is a chance of generating strong discharge in the state where a voltage is applied to the scan electrodes Y, the waveform of the second set up signal R_up2 gradually rises and the slope of the waveform of the second set up signal R_up2 is preferably smaller than the slope of the waveform of the first set up signal R_up1.

Therefore, as illustrated in FIGS. 4A and 4B, the slope of the waveform of the first set up signal R_up1 is larger than the slope of the waveform of the second set up signal R_up2 and the waveforms of the first and second set up signals R_up1 and R_up2 are ramp waveforms that gradually rise. As illustrated in FIG. 6, the slope of the first set up signal R_up1 is 90 degrees and the waveform of the second set up signal R_up2 is a ramp waveform that gradually rises.

The invention being thus described, it will be obvious that the same may be varied in many ways. Such variations are not to be regarded as a departure from the spirit and scope of the invention, and all such modifications as would be obvious to one skilled in the art are intended to be comprised within the scope of the following claims.

What is claimed is:

1. A plasma display apparatus comprising:
a set up driver comprising at least two switches each connected to a different source, for supplying a scan electrode with a set up signal rising in at least two steps during a reset period, and
a set up controller for controlling a switching timing so that the at least two switches are turned on substantially at the same time,

2. The plasma display apparatus as claimed in claim 1, wherein
the two switches comprises a first switch and a second switch,
the first switch is connected to a first source which applies sustain voltage to the scan electrode during a sustain period, the first switch applying a signal gradually rising to the sustain voltage level to the scan electrode, and
the second switch is connected to a second source which applies scan voltage to the scan electrode during an address period, the second switch applying a signal gradually rising to the scan voltage level to the scan electrode.

3. The plasma display apparatus as claimed in claim 2 further comprising:
a scan switch connected to the second source and turned on during the address period.

4. The plasma display apparatus as claimed in claim 2, wherein
the set up controller controls the switch timing so that the first and second switches are turned on only when a voltage of the scan electrode is below the scan voltage level.

5. The plasma display apparatus as claimed in claim 1, wherein
the at least two switches comprises a first switch and a second swtich,
the first switch is connected to a positive sustain voltage source which is applied to the scan electrode during a sustain period, and applies a signal gradually rising to the sustain voltage level to the scan electrode, and
the second switch is connected to a positive scan voltage source which is applied to the scan electrode during an address period, and applies a signal rising to the scan voltage level to the scan electrode.

6. The plasma display apparatus as claimed in claim 5, wherein
the set up controller, primarily, turns on the second switch and turns on the first switch secondarily in a case where a voltage level of the scan electrode, which rises as the second switch is turned on, is below a predetermined voltage level.

7. A plasma display apparatus comprising:
a set up driver comprising a first switch and a second switch for applying a set up signal to a scan electrode, the set up signal gradually rising to a first set up voltage and then gradually rising up to a second set up voltage during a reset period, and
a set up controller for controlling a switching timing so that the first and second switches are sequentially turned on during the reset period.

8. The plasma display apparatus as claimed in claim 7, wherein
the first set up voltage is supplied from a positive sustain voltage source which is applied to the scan electrode during a sustain period as the first switch is turned on, and
the second set up voltage is supplied from a positive scan voltage source which is applied to the scan electrode during an address period as the second switch is turned on.

9. The plasma display apparatus as claimed in claim 8, wherein
the set up controller, primarily, turns on the first switch and turns on the second switch secondarily in a case where a voltage level of the scan electrode, which rises as the first switch is turned on, is below a predetermined voltage level.

10. The plasma display apparatus as claimed in claim 8, wherein
the set up controller, primarily, turns on the second switch and turns on the first switch secondarily in a case where a voltage level of the scan electrode, which rises as the second switch is turned on, is below a predetermined voltage level.

11. The plasma display apparatus as claimed in claim 8, wherein
the second switch is turned on during the address period, and applies a positive scan bias voltage to the scan electrode.

12. A plasma display apparatus comprising:
a set up driver comprising a first switch and a second switch for applying a set up signal to a scan electrode, the set up signal gradually rising to a first set up voltage and then subsequently gradually rising up to a second set up voltage during a reset period, and
a set up controller for allowing either one of the first and second switches to be turned on and controlling a switching timing so that another switch is turned on in a case where a voltage level applied to the scan electrode by the turned on switch is below a predetermined voltage level.

13. The plasma display apparatus as claimed in claim 12, wherein
the first set up voltage is supplied from a positive sustain voltage source which is applied to the scan electrode during a sustain period as the first switch is turned on, and
the second set up voltage is supplied from a positive scan voltage source which is applied to the scan electrode during an address period as the second switch is turned on.

14. The plasma display apparatus as claimed in claim 13, wherein
the second switch is turned on during the address period, and applies a positive scan bias voltage to the scan electrode.

15. The plasma display apparatus as claimed in claim 13, wherein
the predetermined voltage level is a positive scan voltage level.

16. A plasma display apparatus comprising:
a set up driver for applying a set up signal to a scan electrode during a reset period, wherein
the set up signal comprises a first set up signal rising with a first slope, and a second set up signal rising with a second slope, the second set up signal being continuous to the first set up signal, and
the set up signal is supplied in the reset period of a first sub field that forms a frame.

17. The plasma display apparatus as claimed in claim 16, wherein
the first set up signal rises to the scan voltage during the address period, and the second set up signal further rises up to the positive sustain voltage during the sustain period.

18. The plasma display apparatus as claimed in claim 16, wherein
the first set up signal rises to the positive sustain voltage during the sustain period, and the second set up signal further rises up to the scan voltage during the address period.

19. The plasma display apparatus as claimed in claim 16, wherein the first slope is greater than the second slope.

20. The plasma display apparatus as claimed in claim 16, wherein the second slope is below 90 degrees.
